(19) United States
(12) Patent Application Publication
(10) Pub. No.: US 2009/0179539 A1
(43) Pub. Date: Jul. 16, 2009

(54) REFRIGERATOR DOOR STOP

(75) Inventors: Kenneth Henriksson, Motala (SE); Kenneth Andersson, Motala (SE)

Correspondence Address: PEARNE & GORDON LLP, 1801 EAST 9TH STREET, SUITE 1200, CLEVELAND, OH, 44114-3108, US

(73) Assignee: Dometic AB, Stockholm (SE)

(21) Appl. No.: 12/013,674

(22) Filed: Jan. 14, 2008

(51) Int. Cl. A47B 96/00; E05D 11/10

(52) U.S. Cl. 312/405; 16/319

(57) ABSTRACT

A hinge is provided for use with a refrigerator. In one example, the refrigerator includes one or more cabinets having an insulated refrigerator door. A hinge plate is coupled to the cabinet and includes a hinge pin that can be received by an aperture of the door to permit the door to pivot relative to the cabinet and a stop pin. The hinge also includes an intermediate member that has a hole for receiving the hinge pin and a recess for receiving a portion of the stop pin. The intermediate member is pivotable relative to the hinge plate about the hinge pin. The recess of the intermediate member is bounded by a wall, and a portion of the wall forms a stop member for engagement with the stop pin to constrain movement of the intermediate member when the door is pivoted open a predetermined amount relative to the hinge plate.

### RELATED APPLICATIONS

Not applicable.

### FIELD OF THE INVENTION

The present invention relates generally to appliances with doors having hinges, and more particularly, to refrigerator doors having a hinge including a door stop.

### BACKGROUND OF THE INVENTION

As is well known to those versed in the art, it is common to provide refrigerator cabinets with one or more doors. Conventionally, these doors were hinged on one side of the cabinet. When the cabinet hinges were at the side of the cabinet, it was not customary to provide any kind of stop for the door since the door could open without undue strain on the cabinet walls. It has become common practice, however, to provide refrigerators of modern design with hinges that are no longer at the sides of the cabinet. Instead, the hinges often include pintles disposed at the bottom and/or top of the cabinet, and inward of the side, such that the door may be opened without interference with adjacent cabinetry. In this instance it is desirable that a suitable stop means be provided to prevent the door from hitting the adjacent cabinet when opened.

### BRIEF SUMMARY OF THE INVENTION

The following presents a simplified summary of the invention in order to provide a basic understanding of some aspects of the invention. This summary is not an extensive overview of the invention. It is intended to identify neither key nor critical elements of the invention nor delineate the scope of the invention. Its sole purpose is to present some concepts of the invention in a simplified form as a prelude to the more detailed description that is presented later.

In accordance with one aspect of the present invention, a refrigerator includes a cabinet including a refrigerated compartment having an opening, an insulated refrigerator door for covering the opening, and a hinge plate coupled to the cabinet and including a stop pin. The hinge plate is configured to permit the door to pivot relative to the cabinet. The refrigerator also includes an intermediate member coupled to the door and having a recess for receiving a portion of the stop pin. The recess includes a stop member for engagement with the stop pin for constraining movement of the door when the door is pivoted a predetermined amount relative to the cabinet.

In accordance with another aspect of the present invention, a refrigerator includes a cabinet defining a refrigerated compartment having an opening, and an insulated refrigerator door for covering the opening. The door includes an aperture and a hinge plate coupled to the cabinet. The hinge plate includes a hinge pin and a stop pin, and is adapted to be received by the aperture of the door to permit the door to pivot relative to the cabinet. The refrigerator also includes an intermediate member coupled to the door and having a recess for receiving a portion of the stop pin. The recess of the intermediate member is bounded by a wall. A portion of the wall forms a stop member for engagement with the stop pin when the door is pivoted open a predetermined amount relative to the cabinet.

In accordance with yet another aspect of the present invention, a hinge is provided for use with a refrigerator having an insulated refrigerator door. The hinge includes a stationary hinge plate including a hinge pin and a stop pin. In addition, the hinge includes an intermediate member having a hole for receiving the hinge pin and a recess for receiving a portion of the stop pin. The intermediate member is pivotable relative to the stationary hinge plate about the hinge pin. The recess of the intermediate member is bounded by a wall, and a portion of the wall defines a stop member. Engagement of the stop pin with the stop member constrains movement of the intermediate member relative to the stationary hinge plate.

### BRIEF DESCRIPTION OF THE DRAWINGS

The foregoing and other features and advantages of the present invention will become apparent to those skilled in the art to which the present invention relates upon reading the following description with reference to the accompanying drawings, in which:

FIG. 1 illustrates a front view of an example four door refrigerator in accordance with an aspect of the present invention;

FIG. 2 illustrates an exploded view of a hinge assembly for use with a refrigerator door in accordance with an aspect of the present invention;

FIG. 3 illustrates a perspective view of an example hinge plate in accordance with an aspect of the present invention;

FIG. 4 illustrates a bottom view of an example intermediate member in accordance with an aspect of the present invention;

FIG. 5 illustrates a sectional view along line 4-4 of FIG. 3;

FIG. 6A illustrates the hinge of FIG. 2 with a refrigerator door in an open position according to an aspect of the present invention;

FIG. 6B illustrates the hinge of FIG. 2 with a refrigerator door in a closed position according to an aspect of the present invention; and

FIG. 7 illustrates a perspective view of an example end-cap of a refrigerator door in accordance with an aspect of the present invention.

### DESCRIPTION OF EXAMPLE EMBODIMENTS

An example embodiment of a device that incorporates aspects of the present invention is shown in the drawings. It is to be appreciated that the shown example is not intended to be a limitation on the present invention. For example, one or more aspects of the present invention can be utilized in other embodiments and even other types of devices.

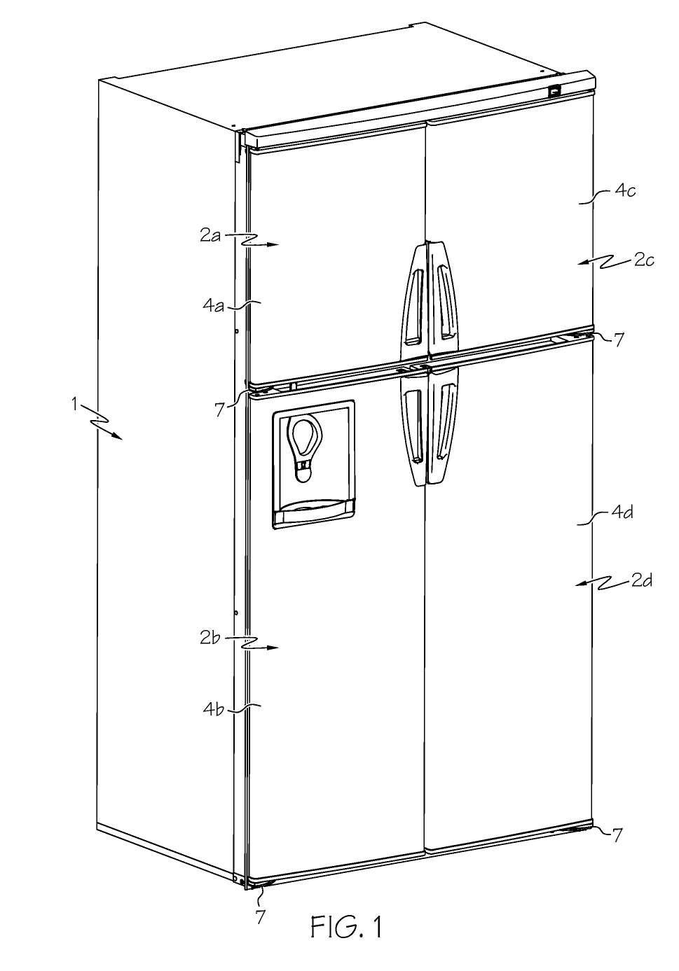

Turning to the illustrated examples, FIG. 1 shows an example refrigerator 1 having a plurality of cabinets 2a-2d covered by a plurality of doors 4a-d. Any or all the cabinets 2a-d can each define a refrigerated compartment that can be cooled or refrigerated, for example, by refrigeration equipment (e.g., a compressor, condenser, and evaporator system, a thermoelectric system, a gas-absorption refrigerator system, etc.) to above-freezing or below-freezing temperatures. Additionally, any or all of the doors 4a-d can be insulated, such as insulated refrigerator doors. However, it is also to be appreciated that the present invention may be employed on various other appliances having one or more doors. Moreover, various numbers of doors and/or cabinets are also contemplated. It is also to be appreciated that the doors 4a-4d may include various features, such as handles of various styles disposed in various locations, various types of ice and/or water dispensers and/or various other accessories disposed thereon.

The doors 4a-d of FIG. 1 can be attached to the refrigerator 1 utilizing the hinge assembly 7 of the present invention. The hinge assembly 7 can be coupled to a door 4a-4d in various locations. For example, the hinge assembly 7 may be connected above, below, at the side, or at various other locations on the door 4a-4d such that the doors 4a-4d may open and close the various cabinets 2a-2d. As shown, all doors 4a-d can be coupled to the refrigerator 1 by a hinge assembly 7 of the present invention. However, it is also to be appreciated that any or all of the doors 4a-d can alternatively be coupled to refrigerator 1 by way of various other devices.

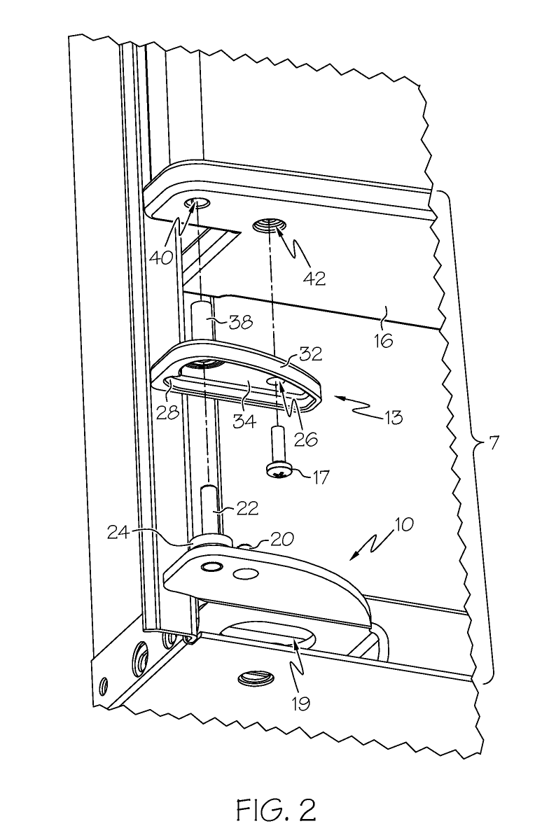

An exploded view of an example hinge assembly 7 is illustrated in FIG. 2. The hinge assembly 7 can include a hinge plate 10, and an intermediate member 13 disposed between the hinge plate 10 and door 4. As shown, the intermediate member 13 can be coupled to a refrigerator door 4a-d, such as to a refrigerator door end-cap 16. In addition or alternatively, the intermediate member 13 can also be coupled to the hinge plate 10, and/or can even remain uncoupled to either of the door 4a-d or hinge plate 10. The intermediate member 13 may be coupled to the door 4a-d in various manners, such as, for example, by fasteners (e.g. screw 17), adhesives, welding, or in various other manners, or can even be formed as part of the door 4. Each component of the hinge assembly 7 may be made of a rigid material, including but not limited to, for example, metal, plastic or hard rubber. It should also be appreciated that each component may be of various shapes and/or sizes, and may be oriented together in various manners to achieve the hinge of the present invention.

As illustrated in FIG. 3, the hinge plate 10 can be coupled to the refrigerator cabinet 2a-2d by way of a coupling plate 18 so that the hinge assembly 7 may be configured to permit the refrigerator door 4a-d to pivot relative to the cabinet 2a-2d. The coupling plate 18 can be attached to or formed with the hinge plate 10 and can include various structures for coupling to the refrigerator frame. For example, as shown, the coupling plate 18 can include holes 21a and/or 21b for use with fasteners secured to the refrigerator frame. The coupling plate holes 21a-21b may be on the side, rear or various other locations of the coupling plate 18. While coupling is illustrated employing fasteners, it is to be appreciated that coupling may be made in various other manners such as for example by adhesives, welding, snap fit, interference fit or in various other manners. The hinge plate 10 can even be formed with the appliance frame. In any event, it is to be appreciated that the hinge plate 10 may be stationary or moveable. The hinge plate 10 can also include various other features, such as an aperture 19 for receiving electrical lines or permitting maintenance. As illustrated, the hinge plate 10 can also include a stop pin 20, a hinge pin 22 and/or a support member 24, as will be discussed more fully herein.

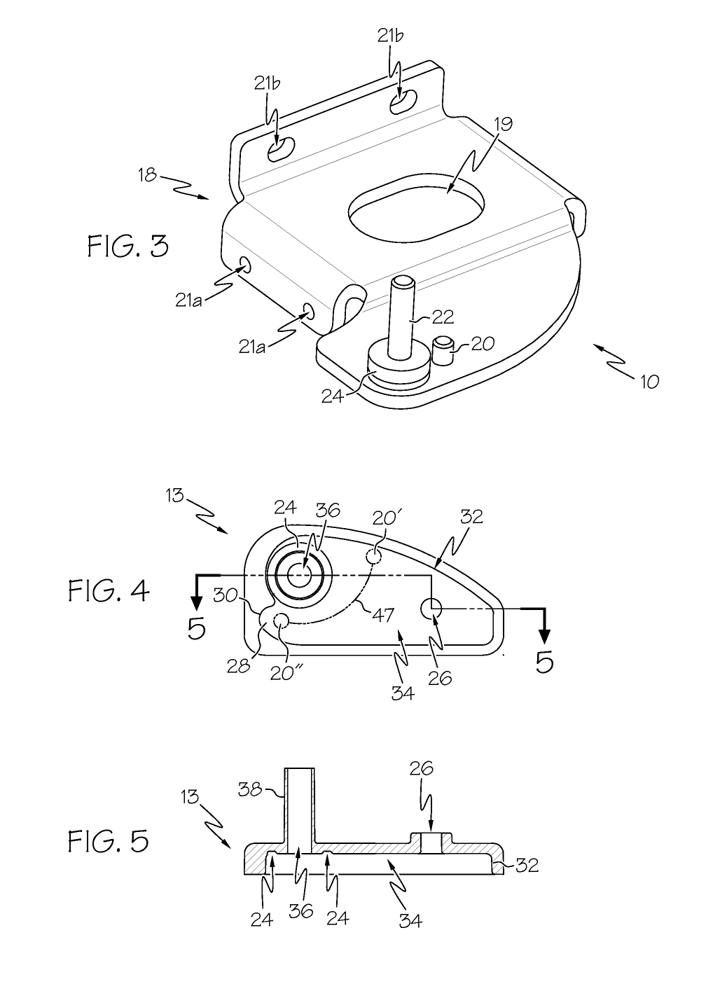

FIGS. 4 and 5 show an intermediate member 13 which can be coupled to the refrigerator door 4 in various manners, such as by employing fasteners 17 via a hole 26. It is to be appreciated that the intermediate member may be coupled to other elements and/or coupled in various other manners, such as those previously referred to, for example. As best shown in FIGS. 4 and 5, the intermediate member 13 can include a recess 28 for receiving a portion of a stop pin 20. The recess 28 can be bounded by a wall 32 that generally follows the outer periphery of the intermediate member 13, though it can have other various shapes. The recess 28 can include a stop member 30 for engagement with the stop pin 20 to thereby constrain movement of the refrigerator door 4 when the door is pivoted a predetermined amount relative to the cabinet 2 and/or stationary hinge plate 10. For example, a portion of the wall 32 may form the stop member 30, such as, for example, by an indentation or projection. The recess 28 may also be bounded by a wall 32 that projects from various other locations other than the intermediate member 13 periphery. The recess wall 32 may also include steps, grooves or be noncontiguous in various other ways. Furthermore, the recess 28 may include various other features, such as, for example, an element that provides feedback to provide tension when a door 4 is opened and/or closed, or a retainer feature to hold the stop pin 20 when the door 4 is opened and/or closed to a predetermined position.

The intermediate member 13 can include other features. For example, the wall 32 can additionally define a recess cavity 34, and the stop pin 20 can be permitted to move generally unconstrained within the recess cavity 34 until the stop pin 20 engages the stop member 30. That is, the intermediate member 13 can move relative to the stop pin 20 in various manners without contacting the stop pin 20. However, it is to be appreciated that the wall 32 may have various depths and/or shapes sufficient to constrain movement of the refrigerator door 4 to the desired limits. The wall 32 may also be of the same or different size as the hinge pin support member 24 and a portion of the wall 32 may be formed to accept the support member 24. The support member 24 can be a bushing, bearing or various other fittings which will help to rotationally support the intermediate member 13 with respect to the hinge. Also illustrated in FIGS. 4 and 5 is a hole 36 extending through the intermediate member 13, which is defined by a sleeve 38 adapted for receiving the hinge pin 22 located on the hinge plate 10. Thus, the intermediate member 13 may pivot relative to the hinge plate 10 about the hinge pin 22. The sleeve 38 can help to guide and/or support the hinge pin 22 relative to the door 4. Though the sleeve 38 is shown as a thru hole, it can also be a blind hole. It is also to be appreciated that pivoting may be achieved in various manners other than use of a hinge pin 22.

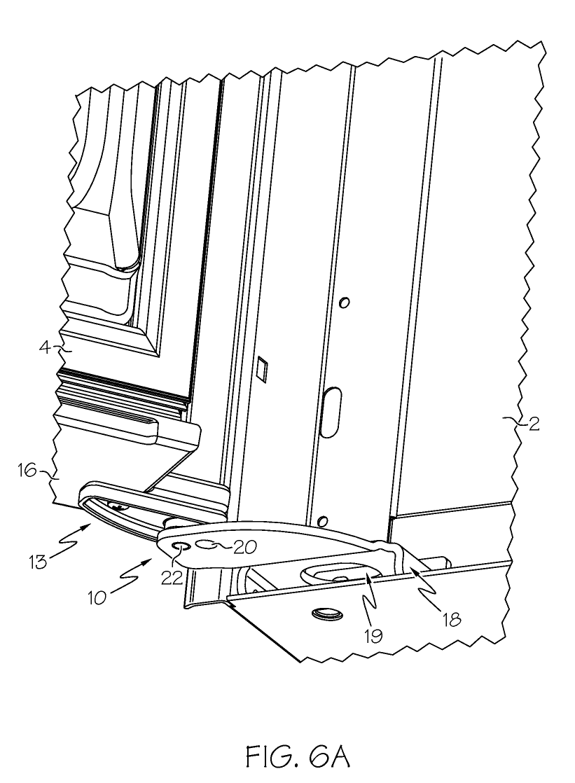

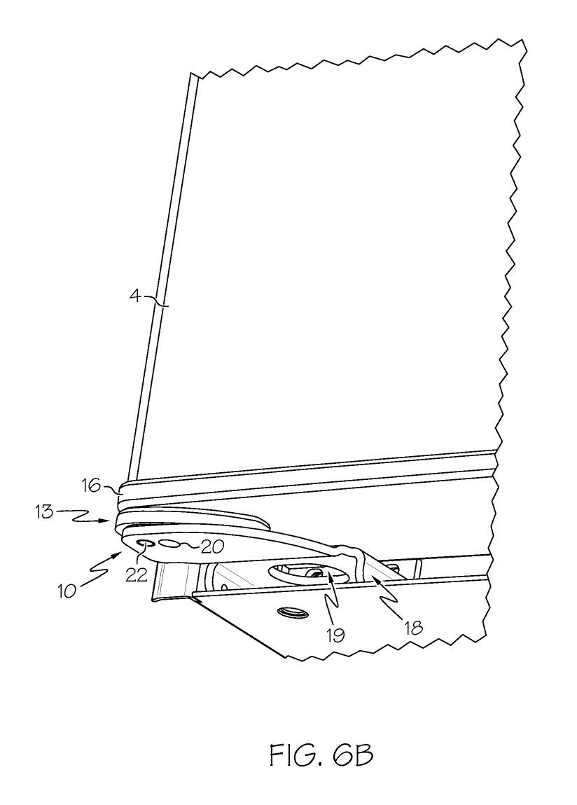

Turning to FIGS. 6A and 6B, the refrigerator door 4 is illustrated with the stop pin 20 of the hinge plate 10 engaging the stop member 30 of the intermediate member 13 such that the door 4 can pivot from a maximum open position (FIG. 6A) to a closed position (FIG. 6B). However, it is to be appreciated that the hinge assembly 7 of the present invention may be configured to allow a door to open or close to various positions. For example, a different stop member 30 shape, stop pin 20 location, and/or hinge pin 22 location may serve to set the boundaries to which the door may open or close. Indeed, any of the stop member 30, stop pin 20 and hinge pin 22 can be adjustable to alter how the door 4 opens and closes.

Operation of the hinge 7 will now be described. In one example embodiment, a refrigerator door aperture 40 receives the sleeve 38 of the intermediate member 13 and the two components are coupled together with a screw 17. In this manner, the refrigerator door 4 is subject to the movement of the intermediate member 13, and vice-versa. The hinge pin 22 of the hinge plate 10 is then guided into the sleeve 38, and thus into the refrigerator door aperture 40. The hinge pin support member 24 provides support to the intermediate member 13 so that the intermediate member 13 and refrigerator door 4 assembly may pivot securely and without excessive misalignment (e.g. wobbling) around the hinge pin 22. The hinge plate coupling plate 18 is then bolted to a refrigerator cabinet 2 frame so that the hinge plate 10 is stationary relative to the refrigerator 1. Alternatively, the hinge plate coupling plate 18 may be bolted to the refrigerator 1 before the door 4 is mounted thereon.

In such an embodiment, the refrigerator door 4 may pivot about the hinge pin 22 to open and close the cabinets 2. When the refrigerator door 4 is in a closed position (see FIG. 6B), the intermediate member 13 is configured so that the hinge plate stop pin 20 may rest against the recess wall 32 in a rest position 20′ or may nominally float within the recess cavity 34 a distance from the wall 32. As the door 4 is pulled open by a user, the intermediate member 13 pivots around the hinge pin 22 causing the stop pin 20 to travel in an arcurate movement 47 within the recess cavity 34 until the stop pin 20 is engaged by the stop member 30 in a stop position 20″. When the door 4 reaches a predetermined open position, the stop pin 20 engages the stop member 30, via abutment therewith, thereby constraining movement of the intermediate member 13 and the refrigerator door 4. Accordingly, engagement of the stop pin 20 with the stop member 30 can inhibit, or even prevent, the door 4 from moving beyond the predetermined open position. Alternatively, multiple stop members (not shown) can provide multiple open positions (e.g. ¾ and full open positions). Further, it is also to be appreciated that pivoting may be achieved in various manners other than use of a hinge pin 22. For example, the intermediate member 13 sleeve 38 could act as a hinge pin itself, thereby permitting the door to pivot in the absence of a hinge plate 10 hinge pin 22.

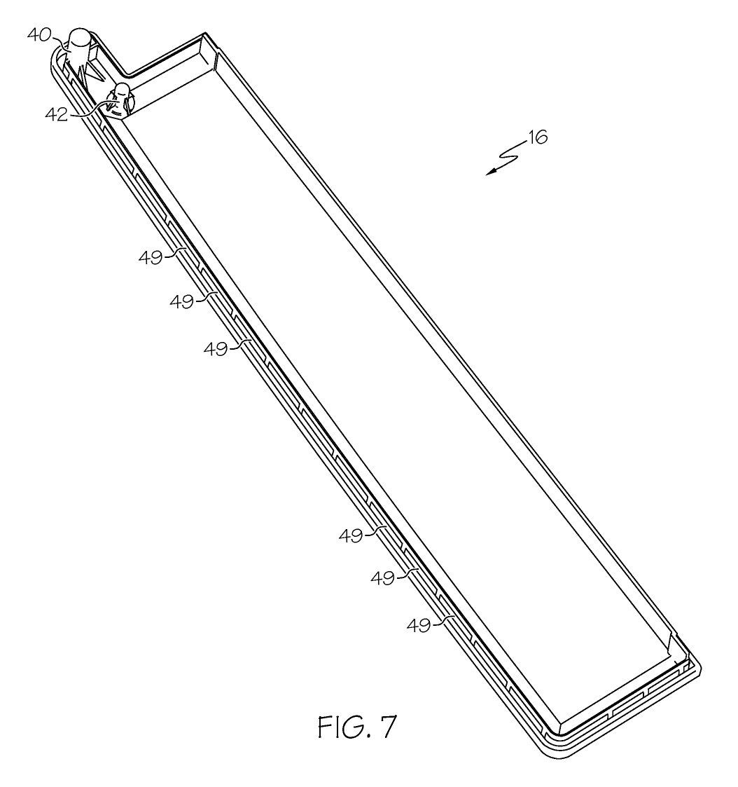

The hinge assembly may further include various other components, such as a refrigerator door end-cap 16 as illustrated in FIG. 7. The end-cap 16 can include an aperture 40 into which the hinge pin 22 is adapted to be received to permit the door 4 to pivot relative to the cabinet 2. Further, the end-cap 16 may include a hole 42 (such as a blind hole) for coupling the intermediate member 13 to the door 4. In one embodiment, the end-cap 16 is made of plastic and is configured to be attached to a metal door 4. However, it is to be appreciated that the end-cap 16 may be made of any rigid material including but not limited to, for example, metal, hard rubber, etc. For example, the end-cap 16 may be coupled to the door 4a-d by a plurality of resilient fingers 49 which are retained in the bottom of the door 4 via an interference fit. It is also to be appreciated that the end-cap 16 may be coupled to the door 4 in various other manners, such as, for example, by fasteners (e.g. screw 17), adhesives, welding, snap fit or in various other manners and may be removable or irremovable. Also, though illustrated, it is to be appreciated that the hinge assembly 7 may be coupled directly to the refrigerator door 4 without the use of an end-cap 16.

Though exemplified above with reference to a refrigerator, it is to be appreciated that the hinge of the subject invention can be used in settings other than in a refrigerator. For example, the hinge of the subject invention could be used in a microwave, freezer, dishwasher, oven, cabinets, washing machine, dryer and/or various other appliances having at least one door.

The invention has been described with reference to the example embodiments described above. Modifications and alterations will occur to others upon a reading and understanding of this specification. Examples embodiments incorporating one or more aspects of the invention are intended to include all such modifications and alterations insofar as they come within the scope of the appended claims.

What is claimed is:

1. A refrigerator, including:
a cabinet defining a refrigerated compartment having an opening;
an insulated refrigerator door for covering the opening;
a hinge plate coupled to the cabinet and including a stop pin, the hinge plate being configured to permit the door to pivot relative to the cabinet; and
an intermediate member coupled to the door and having a recess for receiving a portion of the stop pin, the recess including a stop member for engagement with the stop pin for constraining movement of the door when the door is pivoted a predetermined amount relative to the cabinet.

2. The appliance of claim 1, wherein the stop pin engages the stop member when the door is pivoted to a maximum open position.

3. The appliance of claim 1, wherein the recess is bounded by a wall, a portion of the wall forming the stop member.

4. The appliance of claim 3, wherein the wall of the recess defines a recess cavity, the stop pin being permitted to move generally unconstrained within the recess cavity until the stop pin engages the stop member.

5. The appliance of claim 1, wherein the door further includes an aperture and the hinge plate further includes a hinge pin, the hinge pin being adapted to be received by the aperture of the door to permit the door to pivot relative to the cabinet.

6. The appliance of claim 5, wherein the intermediate member further includes a hole for receiving the hinge pin, the intermediate member being adapted to pivot relative to the hinge plate about the hinge pin.

7. The appliance of claim 6, wherein the intermediate member further includes a sleeve defining the hole, the sleeve being adapted to receive the hinge pin.

8. The appliance of claim 5, wherein the hinge pin further includes a support member adapted to be received within the recess for supporting the intermediate member relative to the hinge plate.

9. A refrigerator, including:
a cabinet defining a refrigerated compartment having an opening;
an insulated refrigerator door for covering the opening, the door including an aperture;
a hinge plate coupled to the cabinet, the hinge plate including a hinge pin and a stop pin, the hinge pin being adapted to be received by the aperture of the door to permit the door to pivot relative to the cabinet; and
an intermediate member coupled to the door and having a recess for receiving a portion of the stop pin, the recess being bounded by a wall, a portion of the wall forming a stop member for engagement with the stop pin when the door is pivoted open relative to the cabinet a predetermined amount.

10. The appliance of claim 9, wherein the stop pin engages the stop member when the door is pivoted to a maximum open position.

11. The appliance of claim 9, wherein the wall of the recess defines a recess cavity, the stop pin being permitted to move generally unconstrained within the recess cavity until the stop pin engages the stop member.

12. The appliance of claim 9, wherein the intermediate member further includes a hole for receiving the hinge pin, the intermediate member being adapted to pivot relative to the hinge plate about the hinge pin.

13. The appliance of claim 9, wherein the hinge pin further includes a support member adapted to be received within the recess for supporting the intermediate member relative to the hinge plate.

14. A hinge for use with a refrigerator having an insulated refrigerator door, including:
a stationary hinge plate including a hinge pin and a stop pin; and
an intermediate member having a hole for receiving the hinge pin and a recess for receiving a portion of the stop pin, the intermediate member being pivotable relative to the stationary hinge plate about the hinge pin, the recess being bounded by a wall, a portion of the wall defining a stop member, and engagement of the stop pin with the stop member constrains movement of the intermediate member relative to the stationary hinge plate.

15. The hinge of claim 14, wherein the stop pin engages the stop member when the door is pivoted to a maximum open position.

16. The hinge of claim 14, wherein the recess is bounded by a wall, a portion of the wall forming the stop member.

17. The hinge of claim 14, wherein the wall of the recess defines a recess cavity, the stop pin being permitted to move generally unconstrained within the recess cavity until the stop pin engages the stop member.

18. The hinge of claim 14, wherein the intermediate member further includes a hole for receiving the hinge pin, the intermediate member being adapted to pivot relative to the stationary hinge plate about the hinge pin.

19. The hinge of claim 14, wherein the intermediate member further includes a sleeve defining the hole, the sleeve being adapted to receive the hinge pin.

20. The hinge of claim 14, wherein the hinge pin further includes a support member adapted to be received within the recess for supporting the intermediate member relative to the stationary hinge plate.
